(19) United States
(12) Patent Application Publication
(10) Pub. No.: US 2017/0272028 A1
(43) Pub. Date: Sep. 21, 2017

(54) INTEGRATED SOUNDWALL AND RENEWABLE ELECTRICAL ENERGY GENERATION SYSTEM AND METAL TUBE FOUNDATIONS THEREFORE

(71) Applicant: Gary L. Reinert, Carnegie, PA (US)

(72) Inventor: Gary L. Reinert, Carnegie, PA (US)

(21) Appl. No.: 15/436,784

(22) Filed: Feb. 18, 2017

Related U.S. Application Data
(60) Provisional application No. 62/309,564, filed on Mar. 17, 2016.

(51) Int. Cl. H02S 20/20; E04H 17/22; E04H 12/22; E02D 5/28; E01F 8/00; E02D 5/54; E02D 5/80; H02K 7/18; F03D 9/25; F03D 9/45; E04H 17/16; E02D 7/06

(52) U.S. Cl. CPC H02S 20/20; E04H 17/16; E04H 17/22; E04H 12/2215; E02D 5/28; E02D 7/06; E02D 5/54; E02D 5/808; H02K 7/183; F03D 9/257; F03D 9/45; E01F 8/0017; E01F 8/0023

(57) ABSTRACT

An integrated soundwall and renewable electrical energy generation system includes a series of metal fin tube foundations; a beam secured to each metal fin tube foundation, wherein the beam includes a lower portion extending into the interior of the metal fin tube and secured thereto, and each beam including channel forming elements; a series of solid fence panels inserted between adjacent beams, with each panel received within the channels formed by adjacent beams; and an electrical energy generator, such as a solar panel array, coupled to select beams above the solid fence panels. Inexpensive energy has always been a boon to spur economic development of a region, and the use of ecologically friendly sources is preferable. The design of the system allows for easy construction of parallel fences to multiply the energy generation with such parallel fences enhancing the barrier aspects of the fence system.

### RELATED APPLICATIONS

This application claims priority to U.S. provisional patent application Ser. No. 62/309,564 filed Mar. 17, 2016, entitled “Integrated Barrier Fence and Renewable Electrical Energy Generation System” invented by Gary Reinert, Sr.

### BACKGROUND OF THE INVENTION

Field of the Invention

The present invention relates to barrier fences and to an integrated barrier fence with renewable electrical generation system.

Background Information

Walls, barriers and the like, collectively called fences herein, have an extremely long history in the field of border security. Consider the famous barrier built 220-206 BCE by Qin Shi Huang, the first Emperor of China, later incorporated into what is known as the Great Wall of China. Also consider Hadrian's Wall, also called the Roman Wall, Picts' Wall, or Vallum Hadriani in Latin, in the Roman province of Britannia, begun in 122 AD during the reign of the emperor Hadrian.

In modern times the border fences serve purposes other than preventing military incursion. The famous Berlin Wall built in 1948 was emblematic of the Cold War and had a primary purpose of preventing emigration out of the communist eastern bloc countries. In the current millennium, consider the 500 KM border fence between Botswana and Zimbabwe built in 2003 stated as being for anti-illegal immigration purposes; a 1400 KM border fence between China and North Korea being built in 2016 stated as being for anti-illegal immigration purposes; a 550 KM border fence in the Indian Kashmir region (disputed territory) built in 2004 stated as being for anti-terrorism purposes; a 2900 KM border fence built in 2000's between South Africa and Zimbabwe stated as being for anti-illegal immigration, anti-drug smuggling, anti-weapon smuggling purposes; and a 1700 KM border fence built in 2001 between Turkmenistan and Uzbekistan stated as being for anti-illegal immigration purposes.

In the field of border fences, various devices and systems must be employed to successfully establish a safe and protected border between various countries and/or between other entities. In order to establish this border and according to the prior art, various fencing and other barrier systems are employed in an attempt to prevent unauthorized vehicles and persons from penetrating the border. Such border security has become a top priority of the United States.

According to the prior art and in connection with border security, current fence barrier systems being utilized involve a significant amount of components that require considerable time to put together during the installation process. First, primary vehicle barriers (sometimes referred to as bollards) are generally installed to prevent or inhibit vehicles from penetrating the border area. Separate primary and secondary fencing has been erected, where appropriate, behind or near these primary vehicle barriers, which provides protection against unauthorized persons from compromising the border.

FIGS. 1A-E illustrate the number of steps needed for the installation of conventional barrier fence systems using concrete foundation supports and precast fencing panels. As shown in FIG. 1A the initial step required access for heavy drilling equipment 12 to engage in drilling operations with a large auger to pre-drill foundation holes 14. This additionally requires the step of disposal of the dirt removed from the hole 14.

FIG. 1B shows the next step which is the installation of a pile reinforcement cage 15 using distinct heavy equipment from the drilling step, namely a hydraulic crane 16. The cage 15 is typically preassembled and delivered to the site.

FIG. 1C shows the next step and illustrates two conventional concrete foundation options, the first being installing a base plate 18 with anchor bolts secured on the top of the cage 15 for later coupling to an entirely above ground beam 20, and the second being a beam 20 is placed into the cage 15. Both options require leveling and supporting braces 22 (which are easily seen in the sunken post 20 option) and proper positioning.

FIG. 1D shows the pouring of the concrete into the prepared holes 14 with cages 14. The concrete requires access by a mixer truck 24. The poured concrete must cure for 3-4 weeks before the remainder of the wall can be installed. The beam 20 is shown in phantom as it may or may not be present depending on the option chosen in FIG. 1C.

FIG. 1E shows the final assembly steps which include removal of the braces 22 and (optionally) attaching the above ground beam 20 on the base plate (if used) then using a crane to install prefabricated panels between channels formed by or coupled to the beams 20.

In addition, in many instances, many prior existing systems were unable to meet all of the United States Customs and Border Patrol performance criteria for the specified “Fence Barrier System”. Further, many current arrangements and methods being used are both costly and timely when trying to meet the required performance criteria given the location, terrain, and accessibility to the border in which the Fence Barrier System is needed.

With regard to an effective and efficient border fence, many of the problems with the prior art are described and addressed in my prior Barrier Fencing System invention described in part in U.S. Pat. No. 8,820,722, which is incorporated herein by reference. Further, many of the components and techniques described in the '722 patent were tested and successfully implemented by the inventor in the construction of vehicle barriers with a metal finned pipe foundation and associated pedestrian fences along the American Mexico border built in 2005-2008. It is my experience as evidenced by the above examples that metal finned foundations provide far superior advantages to the construction of a barrier fencing system than does more common concrete pilings.

There are a number of improvements to be made to the metal finned foundation barrier fence described in the '722 patent to make the barrier system more cost effective and environmentally friendly.

### SUMMARY OF THE INVENTION

The present invention addresses the deficiencies of the prior art and provides an integrated barrier fence with renewable electrical generation system. An integrated barrier fence and renewable electrical energy generation system of the invention allows for the cost effective construction of an effective border fence with integrated energy generation. The integrated solar array and border fence of the invention, with optional wind turbines, transforms a border fence project into a green energy generation system, with the energy generated being able to be sold to the local energy companies to eventually pay for the fence and to stimulate the economies of the areas on both sides of the fence. Inexpensive energy has always been a boon to spur economic development of a region.

The present invention provides an integrated soundwall and renewable electrical energy generation system comprising a series of metal fin tube foundations; a beam secured to each metal fin tube foundation, wherein the beam includes a lower portion extending into the interior of the metal fin tube and secured thereto, and each beam including channel forming elements; a series of solid fence panels inserted between adjacent beams, with each panel received within the channels formed by adjacent beams; and an electrical energy generator, such as a solar panel array, coupled to select beams above the solid fence panels.

The integrated soundwall and renewable electrical energy generation system according to invention may provide wherein the electrical energy generation system is an array of solar panels on a frame attached to select beams. Further each solid fence panel may effectively be a precast concrete member and wherein each beam may effectively be an H or an I beam.

The integrated soundwall and renewable electrical energy generation system according to invention may include wherein each metal fin tube foundation is a polygon tube formed by at least one metal plate. Specifically, each metal fin tube foundation may effectively be an octagon or hexagon tube formed by two pieces, with each piece of the tube including an integral fin and a coupling flange, and wherein each metal fin tube foundation is formed from two identical pieces. Additionally each metal fin tube foundation may effectively be formed as an octagon or hexagon tube formed by a single piece which includes an integral fin and a coupling flange. Additionally each foundation may include an additional non-integral fin welded in place. Alternatively each metal fin tube foundation may be effectively formed as an octagon or hexagon tube formed by a single piece having a gap in a side of the tube for application of a seam welder, wherein each foundation includes a pair of non-integral fins welded in place.

The integrated soundwall and renewable electrical energy generation system according to invention may include that the fins of adjacent foundations substantially span the space between the beams to create a barrier beneath the fence.

The present invention teaches a series of unique metal fin tube foundations for use in the foundations of the present invention.

These and other advantages are described in the brief description of the preferred embodiments in which like reference numeral represent like elements throughout.

### BRIEF DESCRIPTION OF THE FIGURES

FIGS. 1A-E schematically illustrate some of the numerous steps and equipment necessary for the installation of known prior art barrier fencing system using concrete pilings and preformed inter-post panels;

FIGS. 2A-B schematically illustrate the two steps and equipment necessary for the installation of a soundwall according to one aspect of the present invention;

FIG. 3 schematically illustrates an integrated barrier fence and renewable electrical energy generation system according to the present invention implementing solar panels;

FIG. 4 schematically illustrates the installation of the prefabricated panels in the barrier fencing system according to the present invention;

FIG. 5 schematically illustrates the integrated beam and metal fin tube foundation for use in the barrier fencing system according to the present invention;

FIGS. 6A-D schematically illustrate various metal fin tube foundations for use in the barrier fencing system according to the present invention;

FIG. 7 schematically illustrates an integrated barrier fence and renewable electrical energy generation system according to another aspect of the present invention implementing solar panels;

FIG. 8 schematically illustrates the integrated barrier fence and renewable electrical energy generation system according FIG. 7.

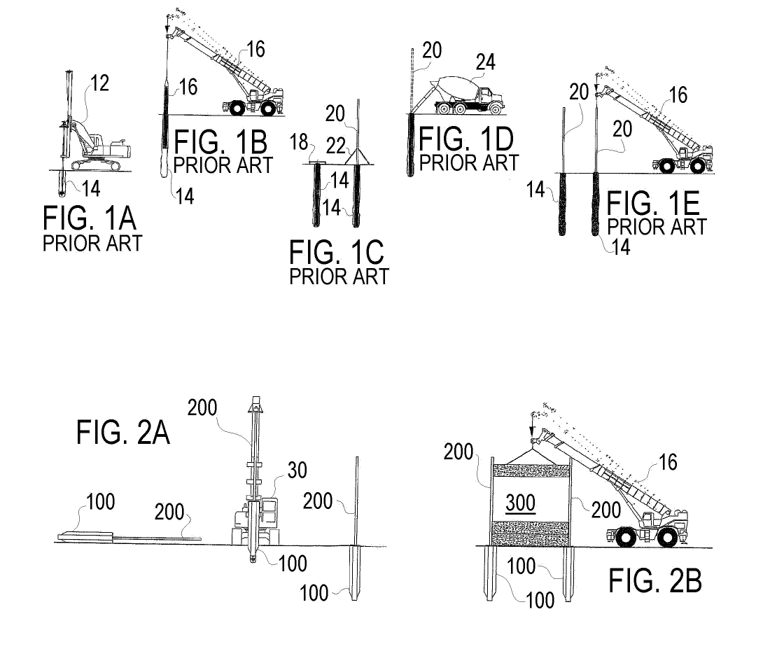

### DESCRIPTION OF THE PREFERRED EMBODIMENTS

The present invention relates barrier fencing systems, in particular soundwall constructions, and those that include electrical power generation components. A soundwall within the meaning of this application is a type of barrier fencing that acts as a noise barrier, and are thus commonly found adjacent highways. According to the Federal Highway Administration noise barriers, in the highway setting, are solid obstructions built between the highway and the homes. They do not completely block all noise they only reduce overall noise levels. Effective noise barriers typically reduce noise levels by 5 to 10 decibels (dB), cutting the loudness of traffic noise by as much as one half. For example, a barrier which achieves a 10-dB reduction can reduce the sound level of a typical tractor trailer pass-by to that of an automobile. Federal requirements for noise barriers may be found in Title 23 of the U.S. Code of Federal Regulations, Part 772, “Procedures for Abatement of Highway Traffic Noise and Construction Noise.” Noise barriers include earthen mounds or berms, which are generally not considered sub-sets of barrier fencing systems in the conventional sense.

FIGS. 2A-B schematically illustrate the two steps and equipment necessary for the installation of a soundwall according to one aspect of the present invention. Metal finned tube foundations 100 which includes integrated channel forming H or I beams 200 welded, or otherwise secured, within the interior 106 of the metal tubes 102 forming the foundations 100 as described below, are delivered to the site and spaced at the desired location. Equipment 30 uses a vibratory hammer to drive the integrated foundation 100 and channel forming beam 200 into position. A vibratory hammer is preferred to the larger impact pile driving devices. As the name implies, vibratory hammers apply a vibratory, also described as an alternating rapidly repetitive force. In granular soils (sands), the vertical vibration in the foundation 100 disturbs or “liquefies” the soil next to the foundation 100 causing the soil particles to lose their frictional grip on the pile. This process is also called thixotropy, from the greek “thixis” for shaking and “trope” for change. With the use of the vibratory hammer, the foundation 100 moves downward under its own weight, plus the weight of the vibratory hammer (additional weight or bias can be added). An amplitude of at least 0.25″(6 mm) is usually considered the minimum to cause enough soil disturbance to achieve effective foundation 100 movement. Adding additional non-vibrating weight (bias weight) will usually aid driving the foundation 100 in granular soil. In cohesive soils (clays), the vibration must shear the soil-to-pile adhesion to allow the foundation 100 to move downward. Again, hammer amplitude of at least 0.25″(6 mm) is usually considered the minimum to cause enough relative movement to shear the soil away from the foundation 100. With less amplitude, the soil will simply move with the foundation 100. The soil under the leading tip of the foundation 100 must also be pushed out from under the foundation 100. This occurs more easily with non-displacement type metal fin tube foundation 100 as shown than with displacement piles of other types and angled or “sharpened” leading bottom edges for the foundation 100 facilitate this operation. FIG. 2B shows the second and final assembly step of using a crane 16 to install prefabricated panels 300 between channels formed by the beams 200. With these two steps the sound wall is completed. The process uses much less physical equipment and much less down time then concrete foundation based systems.

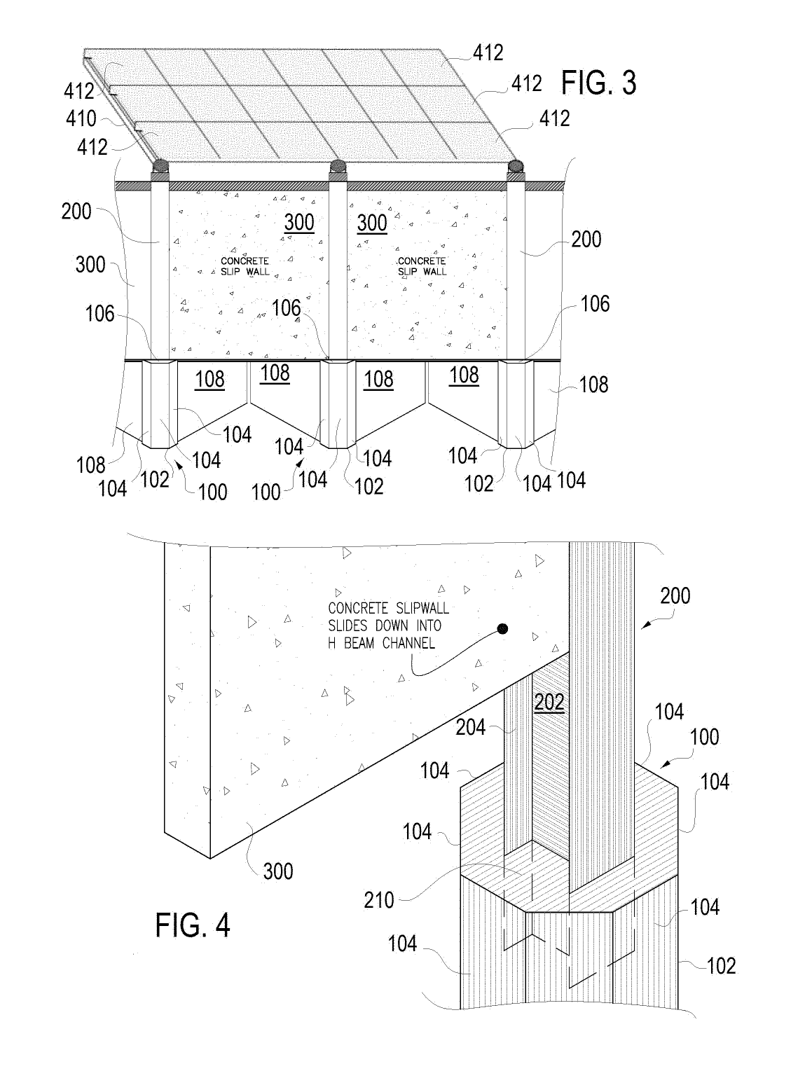

FIG. 3 schematically illustrates an integrated barrier fence and renewable electrical energy generation system according to the present invention implementing solar panels 412 on a frame 410 secured to the beams 200. This integrated system is is essentially added after step 2B to form the integrated barrier fence with renewable electrical generation system, specifically a solar panel array formed by panels 412. Solar panel refers to a panel designed to absorb the sun's rays as a source of energy for generating electricity or heating. Solar panels use light energy (photons) from the sun to generate electricity through the photovoltaic effect. The majority of panels use wafer-based crystalline silicon cells or thin-film cells. The structural (load carrying) member of a module can either be the top layer or the back layer. Cells must also be protected from mechanical damage and moisture. The cells must be connected electrically in series, one to another. Solar panel arrays, per se, are well known and the details of such panel construction and the associated transmission equipment is not included herein. Although the upper layer formed by the solar panels 412 would serve a barrier function on the top of the fence, i.e. hindering persons climbing over the fence, this upper layer is essentially primarily a solar array. One key component of the construction of a solar array of panels 412 is the foundational support for the array via beams 200 and integrated foundations 100.

FIG. 4 schematically illustrates the installation of the prefabricated panels 30 in the barrier fencing system according to the present invention. As noted above each metal finned tube foundation 100 includes an integrated channel forming H or I beam 200 welded, or otherwise secured, within the interior 106 of the metal tubes 102 forming the foundations 100. Preferably the metal tube 102 are formed as a regular polygon structure formed by sides 104, preferably a square, a pentagon, hexagon, septagon or octagon, with hexagon and octagon being more preferable. The beam 200 includes a central web 202 and flanges 204 that form channels for receipt of the concrete panels 300, as shown. A lower part 210 of the beam 200 extends into the interior 106 of the tube 102 and is welded in place to form an integrated structure. The channels of beams 200 on adjacent foundations 100 face each other and are configured to receive a precast panel 300 such as a precast concrete panel as shown. Typically these are 4-7 inches in thickness and up to 12′ wide and up to 12′ high but can be made in any desired shape. Examples are available from Smith-Midland of Midland Va. and AFTEC, LLC of Salt Lake City Utah and concrete Innovation Services of Wilmington N.C.

A critical aspect of the present invention is that the foundational support for a significant border fence (and vehicle barrier) can also serve as the foundational support for an effective and efficient solar array. The combined foundation 100 effectively does (at least) double duty and thus reduces the costs of the system when compared with building each independently. The foundations 100 of the present invention actually serve a multitude of purposes simultaneously increasing the efficiencies of the system. First the foundations 100 serve to support the fence components of panels 300, second they serve to support the array of solar panels 412, third they serve as supports for vehicle bollards, and fourth the extended fins 108 act as a below grade barrier mitigating tunneling under the barrier. The incorporation of all of these functions into the foundations 100 reduces the cost of the overall system.

As an alternative, the solar panels themselves can be incorporated into one or more frame panels forming the body of the fencing between foundational support posts formed by beams 200. Specifically the fence segments between the supporting beams 200 can be formed as a series of rectangular sections, with solar panels added to at least one of these sections. Preferably the solar panels will be placed into frames on the upper half of the fence segments. Not all of the upper half of the segment need be filled with solar panels, and the solar panels can be alternated with conventional fence segments, depending upon design criteria such as the amount of solar panels. Further the upper frame segments of the fencing segments may be constructed to have the integral solar panels angled relative to vertical, generally between 5 to about 25 degrees, to increase the exposure of the solar panels to the sun.

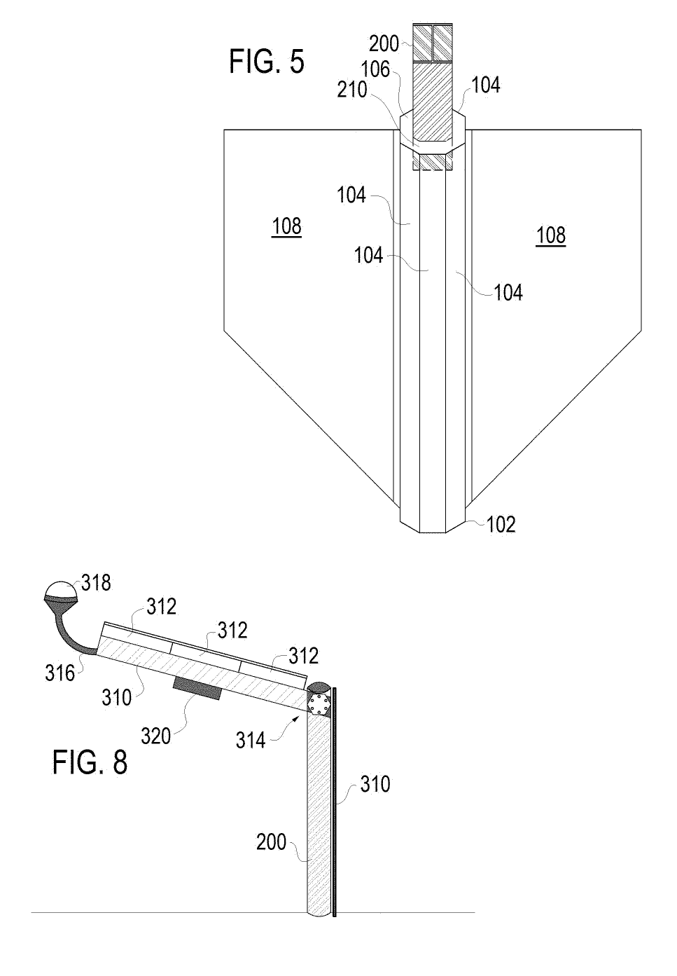

FIG. 5 schematically illustrates the integrated beam 200 and metal fin tube foundation 100 for use in the barrier fencing system according to the present invention. The metal finned tube foundation 100 includes a metal tube 102 formed as a regular polygon structure formed by sides 104 and at least one fin 108, and generally two fins 108 aligned with the general direction of the panels 300 (although not necessarily with each other. The tube 102 includes the lower portion 210 of an integrated channel forming H or I beam 200 extending into the interior 106 of the tube 102 and preferably welded to the interior 106 of the metal tube 102.

A critical component of the present invention is the use of metal finned foundations 100. Metal finned foundations are much more ecologically friendly than concrete foundations. As noted above, typically no excavation is required and installation is much faster. There are two types of metal finned foundations, metal pipe finned foundations and metal tube finned foundations 100.

Metal pipe finned foundations are disclosed in the '722 patent and have a much longer history of use than that. Essentially these comprise of a metal pipe with external fins welded to the exterior. Metal pipe finned foundations are much more environmentally friendly that comparable concrete foundations in these fields. However metal pipe foundations also have some drawbacks, namely that the use of pipe limits the selection of dimensions to conventional pipe sizes and shapes.

Metal tube finned foundations overcome the deficiencies in the metal finned tube foundation and provides metal foundation bodies that are assembled together. In metal tube finned foundations, the fins are part of the metal foundation body. The metal foundations of the metal tube finned foundations is preferably a perimeter geometric shape, a radial geometric shape or if the job requires, both shaped foundations can be combined/used in conjunction with one another. The mechanical fastening can be any known in the field including, but not limited to Huck Bolts, rivets, clips, bolts, studs and clamps. Further details of metal finned tube foundations is found in U.S. Patent Publications 2016-0040386 and 2013-0322970 which are incorporated herein by reference. Aside from the additional green advantages of non-welding attachment, the non-welding attachments of these prior disclosures may increase the costs in a manner that outweighs the advantages such that welding of the structure is preferred.

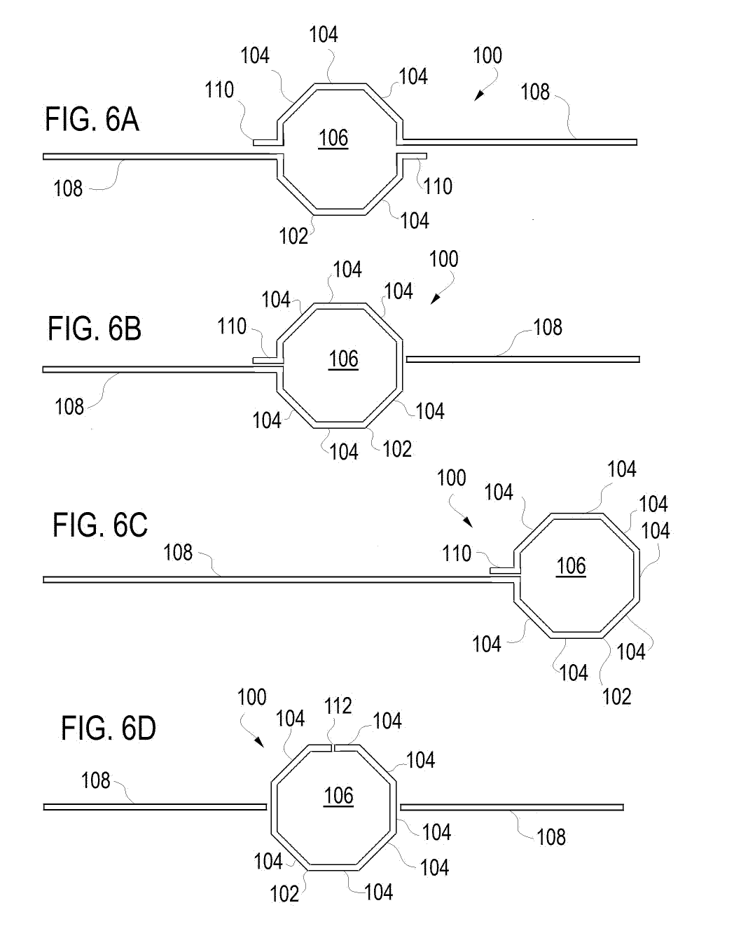

In addition to the shapes disclosed in U.S. Patent Publications 2016-0040386 and 2013-0322970 that are incorporated herein by reference, FIGS. 6A-D schematically illustrate various metal fin tube foundations 100 that are particularly well suited for use in the barrier fencing system according to the present invention each formed from steel plates bent into shape. FIG. 6A illustrates a foundation 100 with an octagon tube 102 formed by two pieces, with each piece of the tube 102 also including an integral fin 108. A coupling flange 110 is also provided to make attachment easier through a simple weld, or optionally through mechanical fasteners if desired. This configuration minimizes pieces that need to be designed and manufactured as the foundation 100 is formed from two identical pieces.

FIG. 6B illustrates a foundation 100 with an octagon tube 102 formed by a single piece, with the tube 102 also including an integral fin 108. A coupling flange 110 is also provided to make attachment easier through a simple weld, or optionally through mechanical fasteners if desired. This embodiment includes an additional non-integral fin 108 that may be welded or otherwise attached in place. FIG. 6C illustrates a foundation 100 with an octagon tube 102 formed by a single piece, with the tube 102 also including an integral fin 108 similar to FIG. 6B. In this embodiment the single integral fin 108 is made to span the substantial distance between adjacent beams 200. FIG. 6D illustrates a foundation 100 with an octagon tube 102 formed by a single piece with no integral fins 108. Separate fins 108 may be added via welding or other attachment as desired. This embodiment allows for seam welder to be used on a gap 112 in a side 104 of the tube 102. As noted above the shape is not limited to octagons or even hexagons as other polygon structures are possible.

Where desired the fins 108 of adjacent foundations may substantially span the space between the beams 200 to create a barrier beneath the fence. The '722 patent discusses the precise alignment of the fins with adjacent fins and with the fence, which is certainly possible, but may not be the most desirable. For example note the construction of the fins 108 in the embodiment of FIG. 6A will have them offset by the distance of the plate. Further, if they are not required to be aligned with the fence, the fins 108 can be positioned for optimal support when considering special wind loading or other design criteria, and can even overlap adjacent fins 108 (in the view represented in FIG. 3). Such overlapping is not possible with aligned fins of the '722 patent. However the fins 108 may certainly be aligned and the orientation of the fins 108 will certainly be known prior to coupling the beams 200 thereto. The fins 108 will likely generally run along with the panels 300 with five degrees or so. Additionally, if the fins 108 do overlap and are formed to extend to each other, the inventor has developed a method of interlocking fins 108 of adjacent foundations, if this is desired, and this system was disclosed to Lawrence Maxwell in early 2013 and appears in a modular foundation system patent application 2015-0059264, which publication is incorporated herein by reference for this teaching.

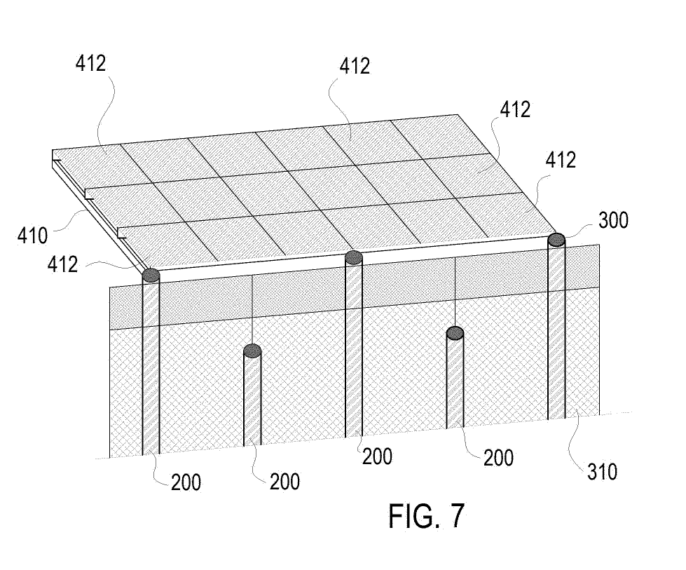

FIG. 7 schematically illustrates an integrated barrier fence and renewable electrical energy generation system according to another aspect of the present invention implementing solar panels 412 on frames 410. Specifically in this embodiment the soundwall construction using precast panels is replaced with more conventional open link wire fencing elements 310. Further in this embodiment with the removal of the cast concrete panels 300 (that themselves serves as vehicle stopping elements), there is shown additional or more frequent foundations and beams 200 to provide the periodic vehicle prevention members needed (i.e. at least every four feet). This addition illustrates one of the advantages of the system shown in FIG. 3, as although the elements 310 are less expensive than the concrete panels 300—this may require the use of twice as many foundations 100 with the associated costs.

FIG. 8 schematically illustrates the integrated barrier fence and renewable electrical energy generation system according FIG. 7 illustrating solar panels 312 on a frame 310 supported via a bolted coupling 314 and including a support 316 for sensors 318 and the like. Additionally lighting 320 is shown.

Further at select locations certain foundations 100 may include an extension pole coupled the top of the beam 200. The mounting pole could be for the alternative mounting of periodic lighting, cameras and sensor equipment as desired. The lighting and cameras and sensor equipment can utilize the onsite power generation for use. Further, in furtherance of the electrical energy generation aspects of the present invention the extension poles may further include mounting of wind turbines. The wind turbines would be in those areas having sufficiently high sustained winds.

As with all engineering projects, each foundation 100 is designed for the particular loads associated with that foundation. The loads in this case may further include the intent to use the foundations 100 as vehicle barriers in the fence system. It is possible that the foundation beams 200 of the invention that support cameras and a sensor platform extend farther than those beams 200 that support only a fence segments 300, while ones supporting a wind turbine extend farther still. Again the specifics will depend upon loads and soil conditions.

The present invention allows the cost effective construction of an effective border fence to further cost effectively integrate energy generation. The integrated solar array and border fence, with optional wind turbines, transforms a border fence project into a green energy generation system, with the energy generated being able to be sold to the local energy companies to eventually pay for the fence and to stimulate the economies of the areas on both sides of the fence. Inexpensive energy has always been a boon to spur economic development of a region. The presence of the fence components allows for easy addition of any energy transportation infrastructure needed for transmission of the energy along the fence to points where it can be disseminated to local energy grids/companies. The design of the system allows for easy construction of parallel fences to multiply the energy generation. Further, parallel fences are also known to enhance the barrier aspects of any fence system.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. An integrated barrier fence and renewable electrical energy generation system.

2. An integrated soundwall and renewable electrical energy generation system comprising:
A series of metal fin tube foundations;
A beam secured to each metal fin tube foundation, wherein the beam includes a lower portion extending into the interior of the metal fin tube and secured thereto, and each beam including channel forming elements;
A series of solid fence panels inserted between adjacent beams, with each panel received within the channels formed by adjacent beams;
An electrical energy generator coupled to select beams above the solid fence panels.

3. The integrated soundwall and renewable electrical energy generation system according to claim 2 wherein the electrical energy generation system is an array of solar panels on a frame attached to select beams.

4. The integrated soundwall and renewable electrical energy generation system according to claim 3 wherein each solid fence panel is a precast concrete member and wherein each beam is an H or an I beam.

5. The integrated soundwall and renewable electrical energy generation system according to claim 4 wherein each metal fin tube foundation is a polygon tube formed by at least one metal plate.

6. The integrated soundwall and renewable electrical energy generation system according to claim 5 wherein each metal fin tube foundation is an octagon or hexagon tube formed by two pieces, with each piece of the tube including an integral fin and a coupling flange.

7. The integrated soundwall and renewable electrical energy generation system according to claim 6 wherein each metal fin tube foundation is formed from two identical pieces.

8. The integrated soundwall and renewable electrical energy generation system according to claim 5 wherein each metal fin tube foundation is an octagon or hexagon tube formed by a single piece which includes an integral fin.

9. The integrated soundwall and renewable electrical energy generation system according to claim 8 wherein the single piece forming the tube of each foundation includes a coupling flange.

10. The integrated soundwall and renewable electrical energy generation system according to claim 8 wherein each foundation includes an additional non-integral fin welded in place.

11. The integrated soundwall and renewable electrical energy generation system according to claim 5 wherein each metal fin tube foundation is an octagon or hexagon tube formed by a single piece having a gap in a side of the tube for application of a seam welder.

12. The integrated soundwall and renewable electrical energy generation system according to claim 11 wherein each foundation includes a pair of non-integral fins welded in place.

13. The integrated soundwall and renewable electrical energy generation system according to claim 5 wherein the fins of adjacent foundations substantially span the space between the beams to create a barrier beneath the fence.

14. A metal fin tube foundation including a polygon tube formed by at least one metal plate.

15. The metal fin tube foundation according to claim 14 wherein each metal fin tube foundation is an octagon or hexagon tube formed by two pieces, with each piece of the tube including an integral fin and a coupling flange.

16. The metal fin tube foundation according to claim 15 wherein each metal fin tube foundation is formed from two identical pieces.

17. The metal fin tube foundation according to claim 14 wherein each metal fin tube foundation is an octagon or hexagon tube formed by a single piece which includes an integral fin.

18. The metal fin tube foundation according to claim 17 wherein the single piece forming the tube of each foundation includes a coupling flange.

19. The metal fin tube foundation according to claim 17 wherein each foundation includes an additional non-integral fin welded in place.

20. The metal fin tube foundation according to claim 14 wherein each metal fin tube foundation is an octagon or hexagon tube formed by a single piece having a gap in a side of the tube for application of a seam welder, and wherein each foundation includes a pair of non-integral fins welded in place.
